(19) United States
(12) Patent Application Publication
(10) Pub. No.: US 2026/0088717 A1
(43) Pub. Date: Mar. 26, 2026

(54) SWITCHING CONVERTER WITH NEGATIVE VOLTAGE FEEDBACK

(71) Applicant: TEXAS INSTRUMENTS INCORPORATED, Dallas, TX (US)

(72) Inventors: Wangfa XU, Shanghai (CN); Sanjay PITHADIA, Dallas, TX (US)

(21) Appl. No.: 18/891,577

(22) Filed: Sep. 20, 2024

(51) Int. Cl. H02M 3/158

(52) U.S. Cl. CPC H02M 3/158

(57) ABSTRACT

A circuit includes an input terminal, a first amplifier, a second amplifier, and a pulse width modulation circuit. The input terminal is configured to receive a negative feedback voltage. The first amplifier has an inverting input coupled to the input terminal, a non-inverting input coupled to a reference terminal, and an output. The second amplifier has a first input coupled to the output of the first amplifier, a second input coupled to a voltage reference terminal, and an output. The pulse width modulation circuit has an input coupled to the output of the second amplifier.

### BACKGROUND

A switching converter is an electronic circuit that converts an input direct current (DC) voltage into one or more DC output voltages that are higher or lower in magnitude, with the same or different polarity, than the input DC voltage. A switching converter that generates an output voltage lower than the input voltage is termed a buck or step-down converter. A switching converter that generates an output voltage higher than the input voltage is termed a boost or step-up converter. A switching converter that generates an output that is either higher or lower than the input voltage is termed a buck-boost converter. Switching converters are widely used to power electronic devices, particularly battery powered devices, such as portable cellular phones, laptop computers, and other electronic systems in which efficient use of power is desirable.

### SUMMARY

In one example, a circuit includes an input terminal, a first amplifier, a second amplifier, and a pulse width modulation (PWM) circuit. The input terminal is configured to receive a negative feedback voltage. The first amplifier has an inverting input coupled to the input terminal, a non-inverting input coupled to a reference terminal, and an output. The second amplifier has a first input coupled to the output of the first amplifier, a second input coupled to a voltage reference terminal, and an output. The pulse width modulation circuit has an input coupled to the output of the second amplifier.

In another example, a circuit includes an error amplifier, a PWM circuit, and a feedback switching circuit. The error amplifier has an input and an output, the error amplifier is configured to provide an error signal representative of a difference of a feedback signal and a reference voltage. The pulse width modulation (PWM) circuit has an input coupled to the output of the error amplifier, and an output, the PWM circuit is configured to provide, at the output of the PWM circuit, a PWM signal based on the error signal. The feedback switching circuit has a feedback input terminal configured to receive a feedback voltage, and an output coupled to the input of the error amplifier. The feedback switching circuit is configured to determine whether the feedback voltage is negative, to invert the feedback voltage to produce a positive feedback voltage, and to provide the positive feedback voltage at the output of the feedback switching circuit.

In a further example, a switching converter includes a transistor, an inductor, and a controller. The transistor has a first terminal, a second terminal coupled to a power supply terminal, and a control terminal. The inductor is coupled to the first terminal of the transistor. The controller includes a PWM circuit, an error amplifier, and a feedback switching circuit. The PWM circuit has an output coupled to the control terminal of the transistor, and an input. The error amplifier has an output coupled to the input of the PWM circuit. The feedback switching circuit has a feedback input terminal configured to receive a feedback voltage, and an output coupled to the input of the error amplifier. The feedback switching circuit is configured to determine whether the feedback voltage is negative, to invert the feedback voltage to produce a positive feedback voltage, and to provide the positive feedback voltage at the output of the feedback switching circuit.

### BRIEF DESCRIPTION OF THE DRAWINGS

FIG. 1 is a schematic diagram of a first example controller suitable for use in positive or negative voltage output switching converters.

FIG. 2 is a schematic diagram of a second example controller suitable for use in positive or negative voltage output switching converters.

FIG. 3 is a schematic diagram of an example switching converter configured to provide a negative output voltage using the controller of FIG. 2.

FIG. 4 is a schematic diagram of an example switching converter configured to provide a positive output voltage using the controller of FIG. 2.

FIG. 5 is a schematic diagram of an example switching converter configured to provide a negative output voltage using the controller of FIG. 2.

### DETAILED DESCRIPTION

Circuits that process analog signals often use both positive and negative power supply voltages. Controller circuits for switch mode power supplies (e.g., controller circuits for buck and boost converters) can be used to generate positive voltages. However, use of such controller circuits for generation of negative voltages is problematic due to the negative feedback voltages generated to control the switching converter. For example, negative voltage may be outside of the operating specifications of the controller circuit. The controller circuits described herein include a feedback switching circuit that enables use of the controller circuits with positive or negative feedback voltages, thereby enabling use of the controller circuits to generate positive or negative power supply voltages.

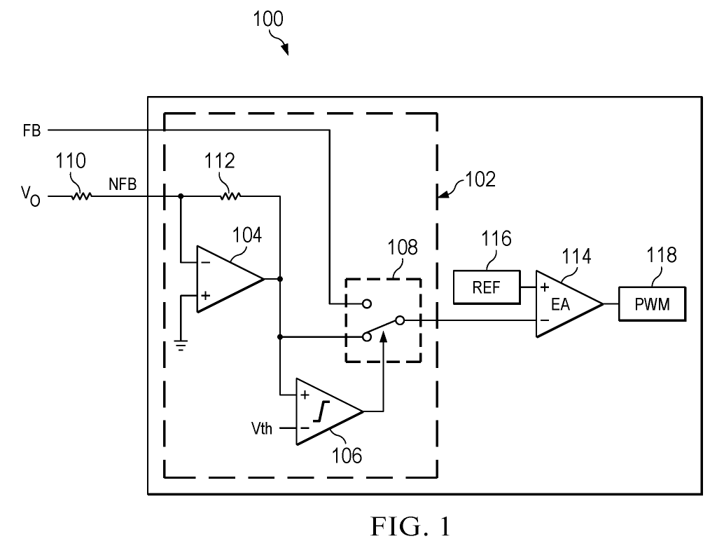

FIG. 1 is a schematic diagram of an example controller 100 suitable for use in positive or negative voltage output switching converters. The controller 100 includes a feedback switching circuit 102, an error amplifier 114, a voltage reference circuit 116, and a pulse with modulation (PWM) circuit 118. The feedback switching circuit 102, the error amplifier 114, the voltage reference circuit 116, and the PWM circuit 118 may be provided on the same integrated circuit. The PWM circuit 118 generates one or more PWM signals to control switching of transistors (not shown) for generation of an output voltage. The PWM circuit 118 has an input coupled to the output of the error amplifier 114. The PWM circuit 118 may generate the PWM signals based on an error signal provided at the output of the error amplifier 114.

The error amplifier 114 has a first input coupled to the feedback switching circuit 102 and a second input coupled to an output of the voltage reference circuit 116. The voltage reference circuit 116 provides a reference voltage at the output. The voltage reference circuit 116 may include a bandgap circuit or other temperature independent voltage generation circuit to provide the reference voltage. The error amplifier 114 compares the reference voltage provided by the voltage reference circuit 116 to a feedback signal provided by the feedback switching circuit 102, and generates the error signal based on the comparison. The error signal represents the difference between the reference voltage and the feedback signal. The PWM circuit 118 generates the PWM signals to minimize the error signal.

The feedback switching circuit 102 provides the feedback signal to the error amplifier 114 for comparison to the reference voltage. The feedback signal may be a scaled output voltage of a switching converter controlled by the controller 100. The feedback switching circuit 102 includes a first input or feedback input terminal (NFB) for receipt of a negative voltage feedback signal, and a second input or feedback input terminal (FB) for receipt of a positive voltage feedback signal. The negative voltage feedback signal may be provided in a switching converter that generates a negative output voltage, and the positive voltage feedback signal may be provided in a switching converter that generates a positive output voltage. Accordingly, the feedback switching circuit 102 enables operation of the controller 100 with positive or negative feedback voltages.

The feedback switching circuit 102 includes an amplifier 104, a comparator 106, and a switch 108. The amplifier 104 is configured as an inverting amplifier. The amplifier 104 has an inverting input coupled to the NFB input of the feedback switching circuit 102, and a non-inverting input coupled to a reference terminal (e.g., ground). A resistor 112 is coupled between the inverting input of the amplifier 104 and the output of the amplifier 104. A resistor 110 may be coupled between the NFB input of the controller 100 and an output (V_{O}) of the switching converter controlled by the controller 100. The resistor 110 may be provided external to the controller 100. The resistances of resistor 112 and resistor 110 determine a ratio for scaling the output voltage of the switching converter.

The output of the amplifier 104 is coupled to the comparator 106 and the switch 108. The comparator 106 has a first input coupled to the output of the amplifier 104 and a second input coupled to a threshold terminal. The comparator 106 compares a threshold voltage provided at the threshold terminal to the inverted feedback signal (inverted feedback voltage) provided at the output of the amplifier 104. If the feedback signal at the output of the amplifier 104 exceeds the threshold voltage, then the signal at the output of the comparator 106 is a logic high (indicating that the feedback signal received at the NFB input is a negative voltage). The threshold voltage provided at the threshold terminal may be, for example, zero volts or a selected fraction (e.g., 1/8, 1/4, 1/2, etc.) of the reference voltage provided by the voltage reference circuit 116.

The switch 108 selects the inverted feedback signal provided at the output of the amplifier 104, or the feedback signal received at the FB input of the feedback switching circuit 102 to provide to the error amplifier 114. The switch 108 may include multiple transistors arranged as a single-pole double-throw switch. The switch 108 has a first terminal coupled to the output of the amplifier 104, a second terminal coupled to the FB input of the feedback switching circuit 102, a third terminal coupled to the first input of the error amplifier 114, and a control input coupled to the output of the comparator 106. If the control signal received at the control input of the switch 108 indicates that the voltage at the NFB input of the feedback switching circuit 102 is negative, then the switch 108 provides the inverted feedback signal to the error amplifier 114, otherwise the switch 108 provides the feedback signal received at the FB input of the feedback switching circuit 102 to the error amplifier 114. Accordingly, the switch 108, controlled by the comparator 106, provides a positive feedback voltage to the error amplifier 114 if a negative feedback voltage is received at the NFB input of the feedback switching circuit 102, or if a positive feedback voltage is received at the FB input of the feedback switching circuit 102. The positive feedback voltage provided by the feedback switching circuit 102 enables the controller 100 to control generation of negative and positive output voltages in a switching converter.

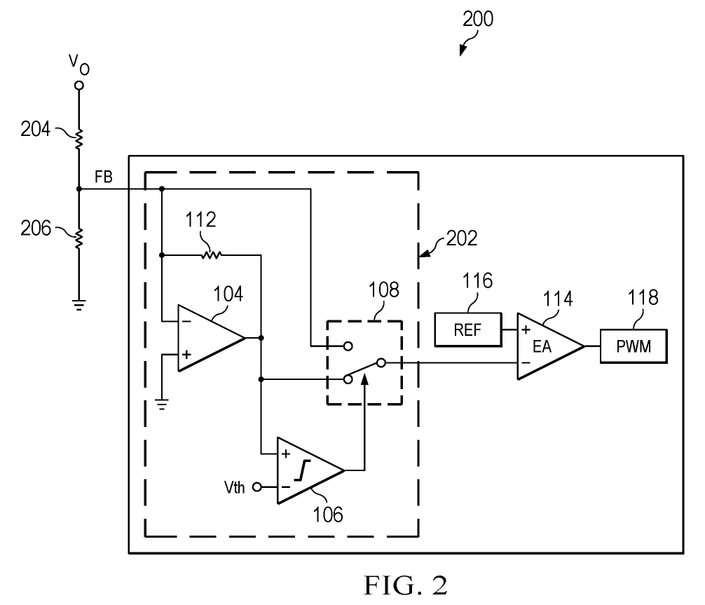

FIG. 2 is a schematic diagram of a second example controller 200 suitable for use in positive or negative voltage output switching converters. The controller 200 includes the error amplifier 114, the voltage reference circuit 116, and the PWM circuit 118 as described with reference to the controller 100. The controller 200 also includes a feedback switching circuit 202 coupled to the error amplifier 114. The feedback switching circuit 202 includes the amplifier 104, the comparator 106, and the switch 108. The feedback switching circuit 202 includes a single feedback input FB for receipt of positive and negative feedback voltages.

The amplifier 104 is configured as an inverting amplifier. The inverting input of the amplifier 104 is coupled to the FB input of the feedback switching circuit 102, and the non-inverting input coupled to a reference terminal (e.g., ground). The resistor 112 is coupled between the inverting input of the amplifier 104 and the output of the amplifier 104. A resistor 204 may be coupled between the FB input of the controller 100 and an output (V_{O}) of the switching converter controlled by the controller 100, and the resistor 206 may be coupled between the FB input of the feedback switching circuit 102 and the reference terminal. The resistor 204 and the resistor 206 may be provided external to the controller 200. The resistances of the resistor 204 and the resistor 206 determine a ratio for scaling the output voltage of the switching converter.

The output of the amplifier 104 is coupled to the comparator 106 and the switch 108. The comparator 106 has a first input coupled to the output of the amplifier 104 and a second input coupled to a threshold terminal. The comparator 106 compares a threshold voltage provided at the threshold terminal to the inverted feedback signal provided at the output of the amplifier 104. If the feedback signal at the output of the amplifier 104 exceeds the threshold voltage, then the signal at the output of the comparator 106 is a logic high (indicating that the feedback signal received at the FB input is a negative voltage). The threshold voltage provided at the threshold terminal may be, for example, zero volts or a selected fraction (e.g., 1/8, 1/4, 1/2, etc.) of the reference voltage provided by the voltage reference circuit 116.

The switch 108 selects the inverted feedback signal provided at the output of the amplifier 104, or the feedback signal received at the FB input of the feedback switching circuit 102 to provide to the error amplifier 114. The switch 108 may include multiple transistors arranged as a single-pole double-throw switch. The switch 108 has a first terminal coupled to the output of the amplifier 104, a second terminal coupled to the FB input of the feedback switching circuit 102, a third terminal coupled to the first input of the error amplifier 114, and a control input coupled to the output of the comparator 106. If the control signal received at the control input of the switch 108 indicates that the voltage at the FB input of the feedback switching circuit 102 is negative, then the switch 108 provides the inverted feedback signal to the error amplifier 114, otherwise the switch 108 provides the feedback signal received at the FB input of the feedback switching circuit 102 to the error amplifier 114. Accordingly, the switch 108, controlled by the comparator 106, provides a positive feedback voltage to the error amplifier 114 if a negative feedback voltage is received at the FB input of the feedback switching circuit 102, or if a positive feedback voltage is received at the FB input of the feedback switching circuit 102. The positive feedback voltage provided by the feedback switching circuit 102 enables the controller 100 to control generation of negative and positive output voltages in a switching converter.

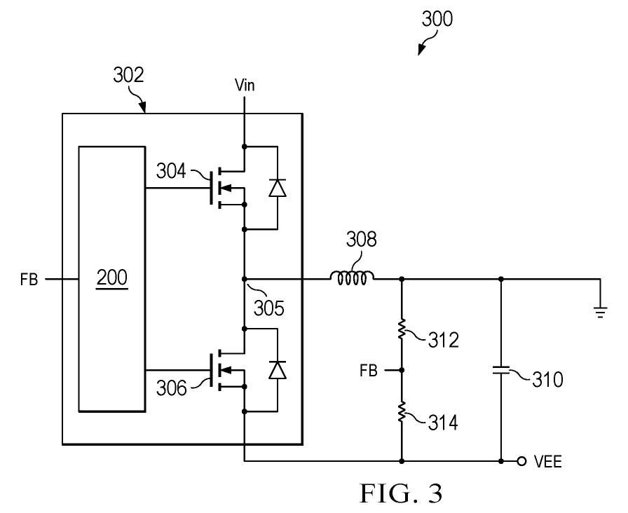

FIG. 3 is a schematic diagram of an example switching converter 300 configured to provide a negative output voltage. The switching converter 300 includes an example of the controller 200, transistors 304 and 306, an inductor 308, resistors 312 and 314, and a capacitor 310. The transistors 304 and 306, and the controller 200 may be provided on an integrated circuit 302 in some examples of the switching converter 300. The transistor 304 has a first terminal (e.g., drain) coupled to an input voltage terminal (VIN), a second terminal (e.g., source) coupled to a switching terminal 305, and a control terminal (e.g., gate) coupled to an output of the controller 200. The transistor 306 has a first terminal (e.g., drain) coupled to the switching terminal 305, a second terminal (e.g., source) coupled to a negative voltage output terminal VEE, and a control terminal (e.g., gate) coupled to an output of the controller 200. The controller 200 may include driver circuitry (not shown) coupled to the PWM circuit 118 to drive the transistor 304 and the transistor 306. The inductor 308 has a first terminal coupled to the switching terminal 305 and a second terminal coupled to the reference terminal (e.g., ground). The capacitor 310 is coupled between the second terminal of the inductor 308 and the second terminal of the transistor 306.

The resistor 312 and the resistor 314 are arranged as a voltage divider to scale the voltage provided between the second terminal of the inductor 308 and the second terminal of the transistor 306. The resistor 312 has a first terminal coupled to the second terminal of the inductor 308 and a second terminal coupled to the FB input of the feedback switching circuit 202. The resistor 314 has a first terminal coupled to the FB input of the feedback switching circuit 202, and a second terminal coupled to the second terminal of the transistor 306. The feedback voltage provided at the FB input of the controller 200 is negative.

The controller 200 detects the negative feedback voltage provided at the FB input of the controller 200 and inverts the negative feedback voltage to provide a positive feedback voltage suitable for operation of the controller 200. Accordingly, the controller 200 is suitable for use in generation of a negative power supply voltage as in the switching converter 300. Examples of the controller 100 may also be used to implement the switching converter 300.

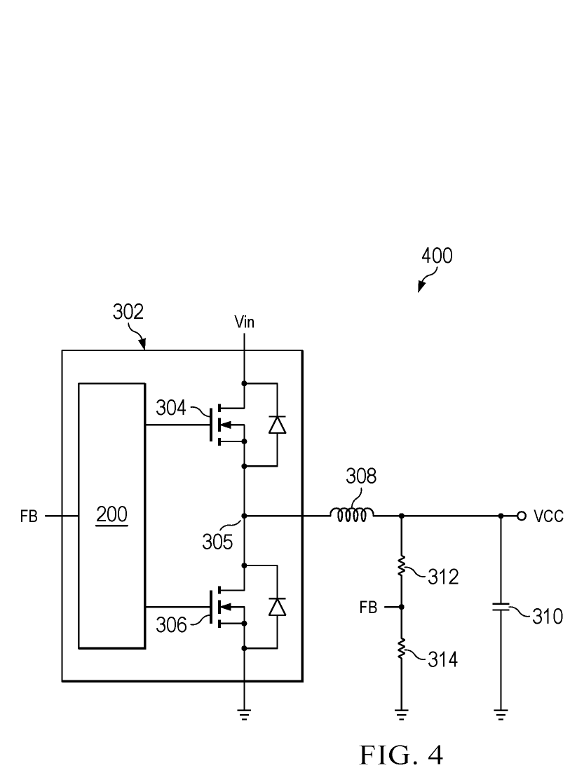

FIG. 4 is a schematic diagram of an example switching converter 400 configured to provide a positive output voltage. The switching converter 400 includes an example of the controller 200, transistors 304 and 306, an inductor 308, resistors 312 and 314, and a capacitor 310. The transistor 304 has a first terminal (e.g., drain) coupled to an input voltage terminal (VIN), a second terminal (e.g., source) coupled to a switching terminal 305, and a control terminal (e.g., gate) coupled to an output of the controller 200. The transistor 306 has a first terminal (e.g., drain) coupled to the switching terminal 305, a second terminal (e.g., source) coupled to a reference terminal (e.g., ground), and a control terminal (e.g., gate) coupled to an output of the controller 200. The controller 200 may include driver circuitry (not shown) coupled to the PWM circuit 118 to drive the transistor 304 and the transistor 306. The inductor 308 has a first terminal coupled to the switching terminal 305 and a second terminal coupled to the output voltage terminal (VCC). The capacitor 310 is coupled between the second terminal of the inductor 308 and the second terminal of the transistor 306.

The resistor 312 and the resistor 314 are arranged as a voltage divider to scale the voltage provided between the second terminal of the inductor 308 and the second terminal of the transistor 306. The resistor 312 has a first terminal coupled to the second terminal of the inductor 308 and a second terminal coupled to the FB input of the feedback switching circuit 202. The resistor 314 has a first terminal coupled to the FB input of the feedback switching circuit 202, and a second terminal coupled to the second terminal of the transistor 306. The feedback voltage provided at the FB input of the controller 200 is positive.

The controller 200 detects the positive feedback voltage provided at the FB input of the controller 200 and provides the positive feedback voltage to the error amplifier 114 for operation of the controller 200. Accordingly, the controller 200 is suitable for use in generation of a positive output voltage as in the switching converter 400. Examples of the controller 100 may also be used to implement the switching converter 400.

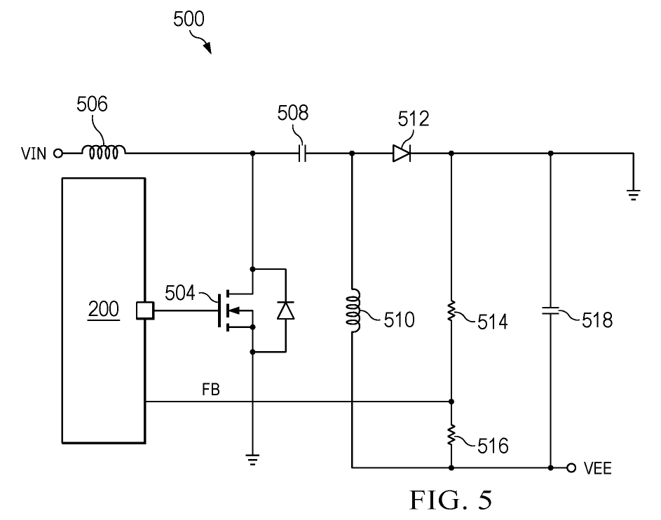

FIG. 5 is a schematic diagram of an example switching converter 500 configured to provide a negative output voltage. The switching converter 500 includes an example of the controller 200, a transistor 504, inductors 506 and 510, a diode 512, resistors 514 and 516, and capacitors 508 and 518. The transistor 504 has a first terminal (e.g., drain) coupled to an input voltage terminal (VIN) via the inductor 506, a second terminal (e.g., source) coupled to the reference terminal (e.g., ground), and a control terminal (e.g., gate) coupled to an output of the controller 200. The controller 200 may include driver circuitry (not shown) coupled to the PWM circuit 118 to drive the transistor 504. The inductor 506 has a first terminal coupled to VIN and a second terminal coupled to the first terminal of the transistor 504.

The capacitor 508 has a first terminal coupled to the first terminal of the transistor 504, and a second terminal coupled to the anode of the diode 512. The cathode of the diode 512 is coupled to the reference terminal (e.g., ground). The inductor 510 is coupled between the second terminal of the capacitor 508 and the negative voltage output terminal (VEE). A first terminal of the inductor 510 is coupled to the second terminal of the capacitor 508, and a second terminal of the inductor 510 is coupled to VEE. The capacitor 518 is coupled between the cathode of the diode 512 and the second terminal of the inductor 510.

The resistor 514 and the resistor 516 are arranged as a voltage divider to scale the voltage provided between the cathode of the diode 512 and the second terminal of the inductor 510. The resistor 514 has a first terminal coupled to the cathode of the diode 512 and a second terminal coupled to the FB input of the controller 200. The resistor 516 has a first terminal coupled to the FB input of the controller 200, and a second terminal coupled to the second terminal of the inductor 510. The feedback voltage provided at the FB input of the controller 200 is negative.

The controller 200 detects the negative feedback voltage provided at the FB input of the controller 200 and inverts the negative feedback voltage to provide a positive feedback voltage suitable for operation of the controller 200. Accordingly, the controller 200 is suitable for use generation of a negative output voltage as in the switching converter 500. Examples of the controller 100 may also be used to implement the switching converter 500.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) (n-type transistor) or a p-channel FET (PFET) ) (p-type transistor)), a bipolar junction transistor (BJT – e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor’s control input and its current terminals. In the context of a FET, the control input (or transistor control terminal) is the gate, and the current terminals are the drain and source. In the context of a BJT, the control input is the base, and the current terminals are the collector and emitter.

References herein to a FET being “ON” means that the conduction channel of the FET is present and drain current may flow through the FET. References herein to a FET being “OFF” means that the conduction channel is not present so drain current does not flow through the FET. An “OFF” FET, however, may have current flowing through the transistor’s body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/- 10 percent of that parameter or, if the parameter is zero, a reasonable range of values around zero.

Modifications are possible in the described embodiments, and other embodiments are possible, within the scope of the claims.

What is claimed is:

1. A circuit comprising:
an input terminal configured to receive a negative feedback voltage;
a first amplifier having an inverting input coupled to the input terminal, a non-inverting input coupled to a reference terminal, and an output;
a second amplifier having a first input coupled to the output of the first amplifier, a second input coupled to a voltage reference terminal, and an output; and
a pulse width modulation circuit having an input coupled to the output of the second amplifier.

2. The circuit of claim 1, further comprising a comparator having a first input coupled to the output of the first amplifier, a second input coupled to a reference terminal, and an output.

3. The circuit of claim 2, wherein:
the input terminal is a first input terminal; and
the circuit includes:
a second input terminal configured to receive a positive feedback voltage; and
a switch having a first terminal coupled to the second input terminal, a second terminal coupled to the output of the first amplifier, a third terminal coupled to the first input of the second amplifier, and a control terminal coupled to the output of the comparator.

4. The circuit of claim 2, further comprising a switch having a first terminal coupled to the inverting input of the amplifier, a second terminal coupled to the output of the first amplifier, a third terminal coupled to the first input of the second amplifier, and a control terminal coupled to the output of the comparator.

5. The circuit of claim 1, further comprising a resistor coupled between the output of the first amplifier and the inverting input of the first amplifier.

6. The circuit of claim 1, further comprising a transistor having a first terminal coupled to a switching terminal, a second terminal coupled to a power supply terminal, and a control terminal coupled to an output of the pulse width modulation circuit.

7. The circuit of claim 6, wherein:
the transistor is a first transistor, the power supply terminal is a first power supply terminal, and the output is a first output; and
the circuit includes a second transistor having a first terminal coupled to a second power supply terminal, a second terminal coupled to the switching terminal, and a control terminal coupled to a second output of the pulse width modulation circuit.

8. The circuit of claim 1, further comprising a resistor coupled between the input terminal and an output terminal configured to provide a negative power supply voltage generated by the circuit.

9. A circuit comprising:
an error amplifier having an input and an output, the error amplifier configured to provide an error signal representative of a difference of a feedback signal and reference voltage;
a pulse width modulation (PWM) circuit having an input coupled to the output of the error amplifier, and an output, the PWM circuit configured to provide, at the output of the PWM circuit, a PWM signal based on the error signal; and
a feedback switching circuit having a feedback input terminal configured to receive a feedback voltage, and an output coupled to the input of the error amplifier, the feedback switching circuit configured to:
determine whether the feedback voltage is negative; and
invert the feedback voltage to produce a positive feedback voltage, and provide the positive feedback voltage at the output of the feedback switching circuit.

10. The circuit of claim 9, wherein the feedback switching circuit includes an inverting amplifier having an input coupled to the feedback input terminal, the inverting amplifier configured to invert the feedback voltage and provide an inverted feedback voltage.

11. The circuit of claim 10, wherein the feedback switching circuit includes a resistor coupled between the output of the inverting amplifier and the input of the inverting amplifier.

12. The circuit of claim 10, wherein the feedback switching circuit includes a comparator having an input coupled to the output of the inverting amplifier, and an output, the comparator configured to compare the inverted feedback voltage to a reference voltage.

13. The circuit of claim 12, wherein:
the feedback input terminal is a first feedback input terminal;
the feedback voltage is a first feedback voltage; and
the feedback switching circuit has a second feedback input terminal configured to receive a second feedback voltage, and the feedback switching circuit includes a switch having a first terminal coupled to the output of the inverting amplifier, a second terminal coupled to the second feedback input terminal, a third terminal coupled to the input of the error amplifier, and a control terminal coupled to the output of the comparator.

14. The circuit of claim 12, wherein the feedback switching circuit includes a switch having a first terminal coupled to the output of the inverting amplifier, a second terminal coupled to the input of the inverting amplifier, a third terminal coupled to the input of the error amplifier, and a control terminal coupled to the output of the comparator.

15. The circuit of claim 9, further comprising a resistor coupled between the feedback input terminal and an output of a switching converter that includes the circuit.

16. The circuit of claim 9, further comprising a transistor having a first terminal coupled to a switching terminal, a second terminal coupled to a power supply terminal, and a control terminal coupled to an output of the PWM circuit.

17. A switching converter comprising:
a transistor having a first terminal, a second terminal coupled to a power supply terminal, and a control terminal;
an inductor coupled to the first terminal of the transistor; and
a controller including:
a pulse width modulation (PWM) circuit having an output coupled to the control terminal of the transistor, and an input;
an error amplifier having an output coupled to the input of the PWM circuit, input; and
a feedback switching circuit having a feedback input terminal configured to receive a feedback voltage, and an output coupled to the input of the error amplifier, the feedback switching circuit configured to:
determine whether the feedback voltage is negative; and
invert the feedback voltage to produce a positive feedback voltage, and provide the positive feedback voltage at the output of the feedback switching circuit.

18. The switching converter of claim 17, wherein the feedback switching circuit includes:
an inverting amplifier having an input coupled to the feedback input terminal, the inverting amplifier configured to invert the feedback voltage and provide an inverted feedback voltage; and
a comparator having an input coupled to the output of the inverting amplifier, and an output, the comparator configured to compare the inverted feedback voltage to a reference voltage.

19. The switching converter of claim 18, wherein:
the feedback input terminal is a first feedback input terminal;
the feedback voltage is a first feedback voltage; and
the feedback switching circuit has a second feedback input terminal configured to receive a second feedback voltage, and the feedback switching circuit includes a switch having a first terminal coupled to the output of the inverting amplifier, a second terminal coupled to the second feedback input terminal, a third terminal coupled to the input of the error amplifier, and a control terminal coupled to the output of the comparator.

20. The switching converter of claim 18, wherein the feedback switching circuit includes a switch having a first terminal coupled to the output of the inverting amplifier, a second terminal coupled to the input of the inverting amplifier, a third terminal coupled to the input of the error amplifier, and a control terminal coupled to the output of the comparator.
